(19) United States
(12) Patent Application Publication
(10) Pub. No.: US 2012/0223881 A1
(43) Pub. Date: Sep. 6, 2012

(54) DISPLAY DEVICE, DISPLAY CONTROL CIRCUIT, AND DISPLAY CONTROL METHOD

(75) Inventor: Masashi Otsubo, Osaka (JP)

(73) Assignee: SHARP KABUSHIKI KAISHA, Osaka (JP)

(21) Appl. No.: 13/509,065

(22) PCT Filed: Aug. 6, 2010
(86) PCT No.: PCT/JP2010/063385

§ 371 Date: May 10, 2012

(30) Foreign Application Priority Data
Nov. 11, 2009 (JP) 2009-257624

(51) Int. Cl. G09G 5/00

(52) U.S. Cl. 345/156

(57) ABSTRACT

In a display control circuit 200 of a display device, a memory control unit 22 sequentially writes image data for one frame included in a display data signal DAT in a prescribed address range of a frame memory 21 on the basis of the starting address that is calculated by a starting address calculation unit 25 and that corresponds to a position serving as a starting point on a screen in accordance with a display position selection signal SEL and on the basis of the display resolution of the display data signal DAT determined by a resolution determination unit 23. With this, the image is not displayed on the entire display screen but can be partially displayed in a predetermined range from the starting point. This leads to display suitable for display devices for specialty applications (typically, for amusements and the like).

### TECHNICAL FIELD

The present invention relates an active matrix type display device, display control circuit, and display control method such as those for a liquid crystal display device or the like using switching elements such as thin film transistors or the like.

### BACKGROUND ART

Generally, an active matrix type liquid crystal display device is equipped with a display unit that includes a pair of substrates sandwiching a liquid crystal layer. One substrate of the pair of substrates is provided with multiple data wiring lines as video signal wiring lines and multiple gate wiring lines as scan signal wiring lines arranged in a matrix pattern. Pixel formation parts are disposed in a matrix pattern corresponding to the intersection points of these multiple data wiring lines and gate wiring lines. The display unit of the device is composed of each of the pixel formation parts. Each pixel formation part includes a thin film transistor (TFT) as a switching element that connects a gate terminal to a gate wiring line and connects a source terminal to a data wiring line. The pixel formation part also includes a pixel electrode that is connected to the drain terminal of this TFT.

This type of active matrix type liquid crystal display device has a data driver for driving the data wiring lines of this display unit, a gate driver for driving the gate wiring lines of this display unit, a common electrode drive circuit for driving the aforementioned common electrode, and a display control circuit for control of the data driver, gate driver, and common electrode driver circuit.

Active matrix type liquid crystal display devices have been widely used in recent years as display devices of portable equipment such as cellular phones, PDAs, or the like and as large scale display devices for television or the like. Many such active matrix type liquid crystal display devices perform high definition display at high resolution.

Normally, image data of the same high degree of resolution is supplied to this type of high resolution display device. However, low resolution data is widely used for the display devices of amusement devices or the like. Since display of such low resolution image data without modification is not possible on a high resolution device, for example, there is a display device that performs a calculation in order to uniformly display low resolution image data over an entire screen region (see Japanese Patent Application Laid-Open Publication No. H6-178237). Additionally, by use of a known converter or the like for conversion of the frequency of the input video signal, it is possible to display low resolution image data over the entire display screen of a high resolution display device.

### RELATED ART DOCUMENTS

### Patent Documents

Patent Document 1: Japanese Patent Application Laid-Open Publication No. H6-178237

### SUMMARY OF THE INVENTION

### Problems to be Solved by the Invention

However, the aforementioned display devices are often general purpose display devices constructed so as to be capable of displaying over the entire display screen image data that has various display resolutions. Therefore, when the aforementioned configuration is used for a display device for certain specialty applications (e.g., a display unit of an amusement device) that always receives low resolution image data and that preferably displays at a certain (apparent) image size, there may be undesirable results such as an excessively large display or the like.

The aforementioned type of problem would not occur if a (low resolution) display device was used that had a display screen of a size appropriate for display of the aforementioned certain large sized image at the same resolution as that of the low resolution aforementioned image data. However, new development and manufacture of such a display device sometimes requires considerable expense, and the use (i.e., conversion) of an existing manufactured and marketed high resolution display device sometimes is less expensive than the use of a low resolution display device.

Therefore, an object of the present invention is to provide a specialty application display device (typically, a display device used for amusements), display control circuit, and display method that do not display over the entire display screen when receiving image data that has a lower resolution than the display resolution that can be displayed on the entire display screen.

### Means for Solving the Problems

In a first aspect, the present invention provides a display control circuit for receiving from an outside an input signal including a plurality of display data for displaying a plurality of pixels constituting an input image and for outputting an image signal for displaying a display image that includes the input image, the display control circuit including: a frame memory that stores respective display data to be included in the image signal by address; an address calculation unit that, in accordance with a display resolution of the input image, calculates addresses at which the plurality of pixels constituting the input image are stored, the display resolution of the input image being lower than a display resolution of the display image; and a memory control unit that writes the plurality of display data included in the input signal into the frame memory at the corresponding addresses that have been calculated by the address calculation unit, the memory control unit outputting the image signal by sequentially reading out the stored plurality of display data.

A second aspect of the present invention is the first aspect of the present invention, wherein the address calculation unit receives instructions specifying a range of addresses corresponding to a position of the plurality of pixels, the position of the plurality of display data being corresponding to a position of the input image within the display image, and the address calculation unit calculates the corresponding addresses in accordance with the instructions.

A third aspect of the present invention is the second aspect of the present invention, wherein the address calculation unit receives instructions specifying the range of addresses such that the input image is displayed within the display image at a position that contacts an edge of the display image.

A fourth aspect of the present invention is the third aspect of the present invention, wherein the address calculation unit stores beforehand a plurality of ranges of addresses that include the range of addresses, and receives instructions to select one range among the plurality of ranges of addresses.

A fifth aspect of the present invention is the first aspect of the present invention, wherein the memory control circuit controls the frame memory such that at a time of activation or when the display resolution of the input image is changed, a plurality of prescribed display data are written onto a prescribed range of addresses that are different from the addresses for the plurality of display data included in the input signal.

A sixth aspect of the present invention is the fifth aspect of the present invention, wherein the memory control unit controls the frame memory such that a plurality of display data for displaying a still image that does not change since the time of activation or change in the display resolution of the input image are written onto the prescribed range of addresses.

A seventh aspect of the present invention is the first aspect of the present invention, wherein the display control circuit further comprises a resolution determination unit that determines the display resolution of the input image based on a synchronization signal included in the input signal, and wherein the address calculation unit calculates the addresses in accordance with the display resolution of the input image received from the resolution determination unit.

An eighth aspect of the present invention is an active matrix type display device that includes: the aforementioned display control circuit as set forth in the first aspect of the present invention; a plurality of video signal wiring lines; a plurality of scan signal wiring lines intersecting the aforementioned plurality of video signal wiring lines; a plurality of pixel formation parts disposed in a matrix corresponding to respective intersections between the aforementioned plurality of video signal wiring lines and the aforementioned plurality of scan signal wiring lines, each of the plurality of pixel formation parts including a switching element that becomes conductive or non-conductive in response to a prescribed scan signal applied to a scan signal wiring line passing through the corresponding intersection point; and a drive control circuit for applying to the aforementioned plurality of video signal wiring lines a plurality of video signals corresponding to the aforementioned image signal output from the aforementioned display control circuit, and for applying the aforementioned scan signal to the aforementioned plurality of scan signal wiring lines.

A ninth aspect of the present invention is a display control method for receiving from an outside an input signal including a plurality of display data for displaying a plurality of pixels constituting an input image, and for outputting an image signal for displaying a display image including the aforementioned input image, the method including: an address calculation step of calculating addresses at which a plurality of pixels constituting the aforementioned input image are written in a frame memory in accordance with a display resolution of the aforementioned input image, the display resolution of the input image being lower than a display resolution of the aforementioned display image, the frame memory being for storing respective display data to be included in the image signal by address; and a memory control step of outputting the aforementioned image signal, the memory control step including writing the aforementioned plurality of display data included in the aforementioned input signal into the frame memory at the corresponding addresses calculated during the aforementioned address calculation step, and sequential reading out the aforementioned stored plurality of display data.

### Effects of the Invention

According to the aforementioned first aspect of the present invention, if display data is received for image data having a resolution (e.g., VGA) that is lower than that which can be displayed on the entire display screen (e.g., SVGA), then the addresses are calculated by the address calculation unit in accordance with the display resolution of the input image, and display data of the aforementioned input image are written to these addresses. It is thus possible to display the input image partially within a range corresponding to the aforementioned addresses instead of displaying the input image over the entire display screen, and it is thus possible to perform display suitable for a display device of specialty applications (e.g., for amusement or the like).

According to the aforementioned second aspect of the present invention, the address calculation unit receives the instructions specifying the address range corresponding to the position of the input image within the display image. It is thus possible to display the input image at the position specified by the instructions.

According to the aforementioned third aspect of the present invention, the address calculation unit receives the instructions specifying an address range set so as to include a position where the input image contacts an end part of the display image within the display image. Because of this feature, even if there is some limitation on installation location of a device containing a display device for a specialized application, such as an amusement device or the like, for example, a limited space can be effectively utilized for installation.

According to the aforementioned fourth aspect of the present invention, the address calculation unit can receive instructions for selecting one among the multiple address ranges. Because of this feature, even if there are various differing needs or limitations on installation space of a device containing a display device for a specialized application, such as an amusement device or the like, for example, installation space can be effectively utilized and installation is made easy by providing suitable instructions.

According to the aforementioned fifth aspect of the present invention, at the time of activation of the device, or when a change of the display resolution of the input image occurs, a plurality of display data, which were predetermined, are written to addresses outside the input image range. Thus, even if the input image changes frame by frame, there is no change in the display data written to the addresses outside the input image range. It is thus possible to effectively use the screen outside the input image range.

According to the aforementioned sixth aspect of the present invention, a plurality of display data for displaying a still image are written to the aforementioned range of addresses. It is thus possible to display various types of images, such as the name of a device, name of a manufacturing company, or the like, with ease, and it is possible to reduce the manufacturing cost because there is no need to add a display device for such display.

According to the aforementioned seventh aspect of the present invention, the display resolution is determined based on the synchronization signal included in the input signal, and the addresses are calculated according to this display resolution. Therefore, the display resolution is obtained automatically from the input signal, and it is possible to omit a display resolution setting step and other related tasks.

According to the aforementioned eighth aspect of the present invention, it is possible to use an active matrix type display device and to realize an effect that is the same as that of the aforementioned first aspect of the present invention.

According to the aforementioned ninth aspect of the present invention, it is possible to use a display control method to realize an effect that is the same as that of the aforementioned first aspect of the present invention.

### BRIEF DESCRIPTION OF THE DRAWINGS

FIG. 1 is a block diagram showing the overall structure of an active matrix type liquid crystal display device according to an embodiment of the present invention.

FIG. 2 is a schematic drawing showing a structure of the display unit of an active matrix type liquid crystal display device.

FIG. 3 is a circuit diagram showing an equivalent circuit of the pixel formation part of the active matrix type liquid crystal display device.

FIG. 4 is a block diagram showing a configuration of the display control circuit of the aforementioned embodiment.

FIG. 5 shows the contents of a frame memory of the aforementioned embodiment at the time of device initiation, prior to the writing of each pixel value.

FIG. 6 shows the contents of the frame memory of the aforementioned embodiment when respective pixel values are written such that an image is to be displayed at the center of the screen.

FIG. 7 shows the contents of the frame memory of the aforementioned embodiment when respective pixel values are written such that an image is to be displayed at the upper left corner of the screen.

FIG. 8 shows the contents of the frame memory of the aforementioned embodiment when respective pixel values are written such that an image is to be displayed at the lower right corner of the screen.

FIG. 9 is a front exterior view of a amusement device containing this liquid crystal display device of the aforementioned embodiment.

FIG. 10 is a diagram showing the contents of the frame memory of the aforementioned embodiment when respective pixel values are written such that images are to be displayed at the upper left corner and at the lower right corner of the screen.

### DETAILED DESCRIPTION OF EMBODIMENTS

### 1. OVERALL STRUCTURE AND OPERATING OF THE LIQUID CRYSTAL DISPLAY DEVICE

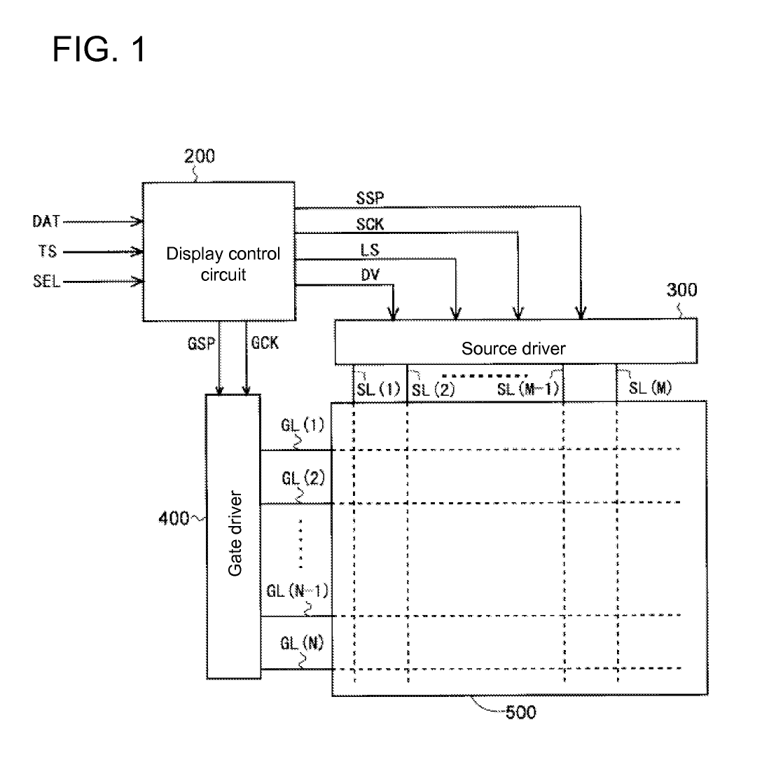

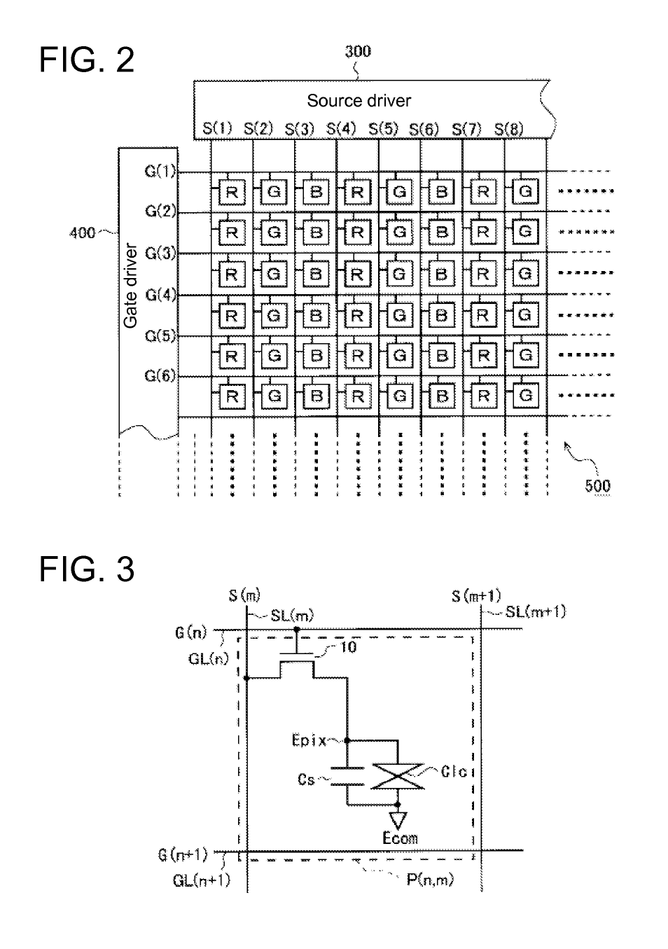

FIG. 1 is a block diagram showing an overall structure of an active matrix type liquid crystal display device according to an embodiment of the present invention. This liquid crystal display device is equipped with a display unit 500 and a drive control unit composed of a display control circuit 200, a source driver 300 (video signal wiring line drive circuit), and a gate driver 400 (scan signal wiring line drive circuit). The display unit 500 includes multiple (M lines, where M=800×3 in this case) video signal wiring lines SL(1) through SL(M), multiple (N lines, where N=600 in this case) scan signal wiring lines GL(1) through GL(N), and multiple (M×N) pixel formation parts that are each arranged at a respective intersection point between these multiple video signal wiring lines SL(1) through SL(M) and multiple scan signal wiring lines GL(1) through GL(N), as shown in FIGS. 2 and 3. Hereinafter, the pixel formation part corresponding to the intersection point of the scan signal wiring line GL(n) and the video signal wiring line SL(m) will be indicated by the reference symbol “P(n, m).”

Although this liquid crystal display device is constructed so as to be capable of a so-called SVGA color display, the image data to be inputted are for the VGA display in the below descriptions, display is performed in a manner different from the normal SVGA display. Details will be described below.

Here, FIG. 2 shows a schematic configuration of the display unit 500 of the present embodiment, and FIG. 3 shows an equivalent circuit of the pixel formation part P(n, m) of this display unit 500. As shown in FIGS. 2 and 3, a pixel formation part P(n, m) includes a switching element TFT 10 having a gate terminal connected to the scan signal wiring line GL(n) that passes the corresponding intersection point, and a source terminal connected to the video signal wiring line SL(m) that passes the corresponding intersection point; a pixel electrode Epix connected to the drain terminal of this TFT 10; a common electrode Ecom (also referred to as the “counter electrode”) provided in common for the aforementioned plurality of pixel formation parts P(i, j) (i=1 through N, j=1 through M); and a liquid crystal layer as an electrooptic element sandwiched between the pixel electrode Epix (provided in common for the aforementioned multiple pixel formation parts P(i, j), i=1 through N, j=1 through M) and the common electrode Ecom.

Each pixel formation part P(n, m) displays one of the colors, i.e., red (R), green (G), or blue (B). As shown in FIG. 2, pixel formation parts P(n, m) displaying the same color are arranged along the direction of the video signal wiring lines SL(1) through SL(M), and the pixel formation parts P(n, m) are arranged in RGB order along the direction of the scan signal wiring lines GL(1) through GL(N).

At each pixel formation part P(n, m), a liquid crystal capacitance Clc is formed by the pixel electrode Epix and the common electrode Ecom sandwiching the liquid crystal layer therebetween, and an auxiliary capacitance Cs is formed in the vicinity.

When the scan signal G(n) applied to the scan signal wiring line GL(n) becomes active, the TFT 10 is selected by this scan signal and enters into the conductive state. Then, the drive video signal S(m) is applied to the pixel electrode Ep through the video signal wiring line SL(m). This way, the voltage applied by the drive video signal S(m) (i.e., voltage relative to the potential of the common electrode Ec as a reference) is written as a pixel value to the pixel formation part P(n, m) that includes this pixel electrode Ep.

The display control circuit 200 receives the display data signal DAT, timing control signal TS, and display position selection signal SEL sent from the outside. The display control circuit 200 outputs a digital video signal DV, a source start pulse signal SSP for controlling timing of the display of the image by the display unit 500, a source clock signal SCK, a latch strobe signal LS, a gate start pulse signal GSP, and a gate clock signal GCK.

Here, the display data signal DAT from the outside is the image data used for a VGA display. This is a digital RGB signal that includes a total of 24 bits of parallel data composed of the red color display data DR, green color display data DG, and blue color display data DB, in which each data is 8 bits to be applied to a corresponding pixel formation part. This display data signal DAT is temporarily stored in the display control circuit 200 (in a frame memory therein as described below), is converted so as to be displayed in a screen position in accordance with the display position selection signal SEL received from the outside, and is output as the digital video signal DV.

The source driver 300 receives the digital video signal DV, the source start pulse signal SSP, the source clock signal SCK, and the latch strobe signal LS, which were output from the display control circuit 200, and applies to each video signal wiring line SL(1) through SL(M) a drive video signal for charging the pixel capacitance at each pixel formation part P(n, m) in the display unit 500. To do this, in accordance with timing of the source clock signal SCK pulse, the source driver 300 sequentially retains the digital video signal DV indicating the voltages to be applied to respective video signal wiring lines SL(1) through SL(M). Then, according to the timing of the pulses of the latch strobe signal LS, the aforementioned retained digital video signal DV is converted to analog voltages. The converted analog voltages are applied to all of the respective video signal wiring lines SL(1) through SL(M) at once as the drive video signals. That is to say, the line sequential drive method is adopted by the present embodiment for driving the video signal wiring lines SL(1) through SL(M).

Based on the gate clock signal GCK and the gate start pulse signal GSP output from the display control circuit 200, the gate driver 400 applies active scan signals to the respective scan signal wiring lines GL(1) through GL(N).

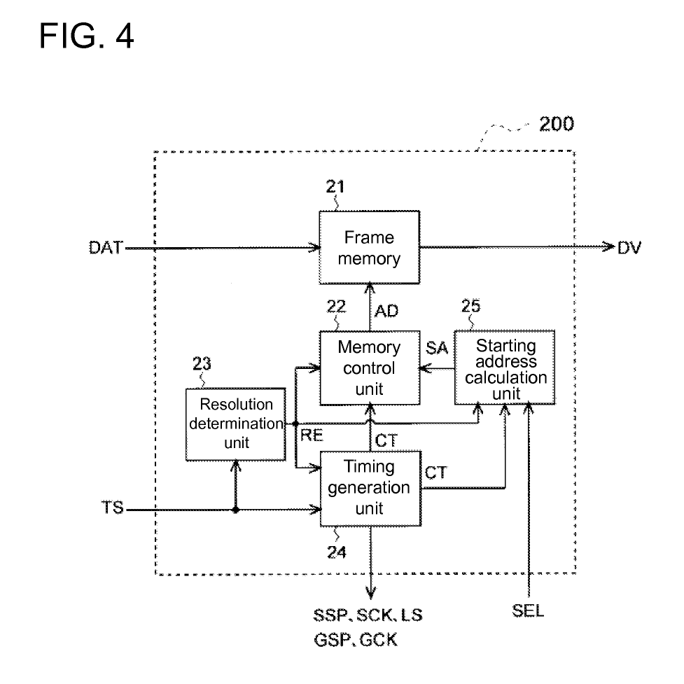

In a manner described above, drive video signals are applied to the respective video signal wiring lines SL(1) through SL(M) and the scan signals are applied to the respective scan signal wiring lines GL(1) through GL(N) so that an image is displayed by the display unit 500. The common electrode Ecom receives a certain voltage supplied by a non-illustrated electrical power supply circuit and is held at the common electrode potential Vcom. Next, FIG. 4 will be referred to while describing the operation and configuration of a display control circuit 200 for the display of an image of a size corresponding to a VGA screen (referred to hereinafter as the “VGA image”) at a certain position on the SVGA display screen.

### 2. STRUCTURE AND OPERATION OF THE DISPLAY CONTROL CIRCUIT

FIG. 4 is a drawing showing a configuration of the display control circuit 200 of the present embodiment. This display control circuit 200 is provided with a frame memory 21 for each (RGB) color pixel for storing the pixel values (i.e., gradation data) included in the display data signal DAT given from outside the device, a memory control unit 22 for controlling writing and reading the aforementioned pixel values to and from the frame memory 21, a resolution determination unit 23 for determining the display resolution of the aforementioned display data signal DAT, a timing generation unit 24 for performing timing control, and a starting address calculation unit 25 for calculating a starting address in accordance with the display position selection signal SEL provided from outside the device.

The resolution determination unit 23 receives the timing control signal TS, which is a synchronization signal sent from the outside, and counts the number of pulses of the horizontal synchronization signal (referred to hereinafter as the “line count”) included in that signal for a single screen (i.e., 1 frame) and the number of clocks (referred to hereinafter as the “dot count”) included in this pulse interval (in a single horizontal synchronization interval), which corresponds to the number of the display data per one line. As described above, since the image to be displayed using the display data signal DAT is assumed to be for VGA, the dot count is 640, and the line count is 480. The memory control unit 22, the timing generation unit 24, and the starting address calculation unit 25 are provided with these numbers as the resolution data RE. That is to say, in the present specification, the term “resolution” or “display resolution” means the numbers of the dot count and line count of the image to be displayed in a single screen, and these values become larger as the resolution increases.

Based on the timing control signal TS sent from the outside, the timing generation unit 24 outputs a control signal CT for controlling operations of the starting address calculation unit and the memory control unit 22, and based on the resolution data RE received from the resolution determination unit 23, the timing generation unit 24 converts the timing control signal TS from the outside such that it has timing that matches the SVGA display (specifically, the pulse period is reduced and pulses are supplemented). Based on the converted timing, the timing generation unit 24 outputs to the display unit 500 the source start pulse signal SSP for control of timing for display of the (SVGA) image, the source clock signal SCK, the latch strobe signal LS, the gate start pulse signal GSP, and the gate clock signal GCK.

The frame memory 21 stores in a prescribed memory region of a memory device (i.e., a not-illustrated semiconductor memory or the like) respective pixel values for a single frame image included in the display data signal DAT sent from the exterior. As described above, in order to display the colored pixels formed of red colored (R), green colored (G), and blue colored (B) pixel formation parts in the above described manner, this pixel value is composed of 24 bits of data for displaying the colored pixel, and a single pixel value is assigned to a single address.

Based on the display position selection signal SEL forwarded from outside the device and the resolution data RE forwarded from the resolution determination unit 23, the starting address calculation unit 25 calculates a starting address for the initial writing of pixel values among the image data of a single frame image included in the display data signal DAT. The calculated starting address SA is provided to the memory control unit 22.

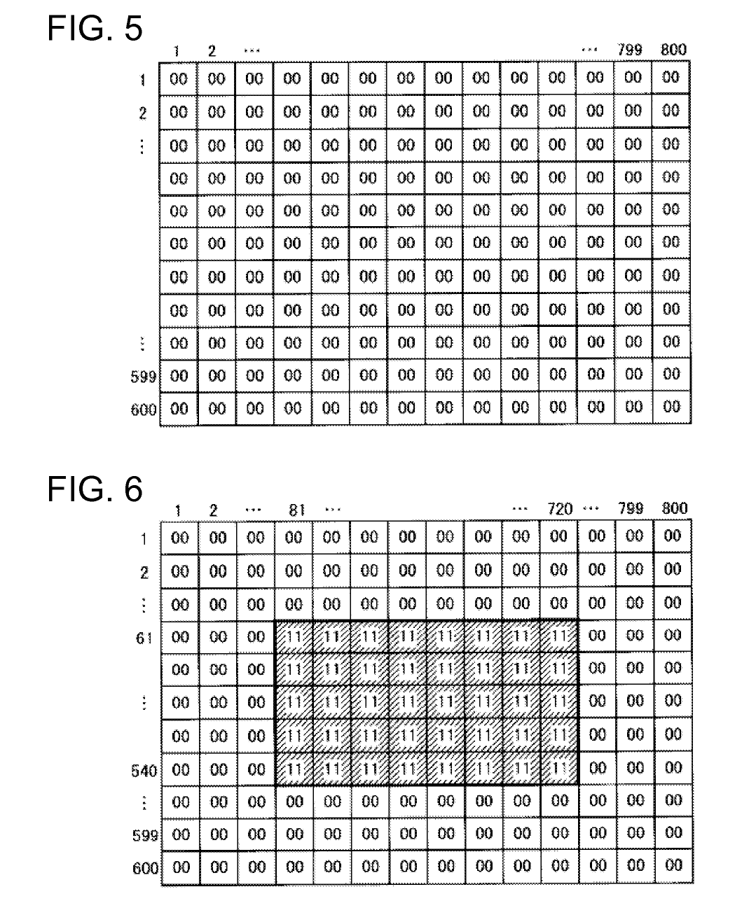

The memory control unit 22 writes to the starting address SA the initial pixel value of the image data of a single frame image included in the display data signal DAT, and writes all the pixel values included in the image data of the aforementioned frame image sequentially in a prescribed address range that is calculated based on the resolution data RE taking the starting address SA as a point of origin. The contents of the frame memory 21 in which such pixel values have been written as well as the aforementioned starting address SA will be described with reference to FIGS. 5 and 6.

FIG. 5 is a drawing that shows the contents of the frame memory at the time of device activation prior to writing of each pixel value. FIG. 6 is a drawing showing the contents of the frame memory to which each pixel value has been written such that an image is to be displayed at the center of the screen.

The contents of the frame memory shown in FIGS. 5 and 6 are respectively a group of pixel values arranged in a matrix corresponding to a display screen of 800 columns and 600 rows. These pixel values are indicated below by PD(p, q), where p is an integer that is less than or equal to 800, and q is an integer that is less than or equal to 600. Here, this pixel value PD(p, q) is 24 bits of data, and takes an integer within a prescribed range of 0 to 255 in a RGB sequence as a gradation value. For example, the pixel value PD(81,61) is the pixel value at the 81st column and the 61st row of the display screen. In the case shown in FIG. 5, the value is “00,” and in the case shown in FIG. 6, the value is “11.”

The actual addresses in the frame memory 21 are represented by p+800×(q−1) in hexadecimal, for example. However, for convenience of the description, the addresses corresponding to the pixel coordinates on the display screen are expressed in the form of the array (p, q). Therefore, the address of the pixel value PD (81,61) is (81,61), and in the example shown in FIG. 6, this particular address is the starting address SA calculated by the starting address calculation unit 25. Any scheme can be used to express addresses in the frame memory, which include the starting address SA, as long as it uniquely determines a pixel value. Any method is acceptable if it enables writing of respective pixel values to the frame memory 21, and reading of respective pixels values from the frame memory 21.

For convenience of the description, in FIG. 6, all the pixel values of the single frame portion included in the display data signal DAT are “11,” and a color prescribed in accordance with this value is displayed at the corresponding coordinates of the display unit 500. Furthermore, with respect to the addresses in the frame memory 21 other than those where the aforementioned pixel values have been written, a pixel value of “00” is written at the time of initializing the frame memory 21 during the device activation period (and when the starting address is changed), and black colored pixels corresponding to this value are displayed at the corresponding coordinates on the display unit 500.

Furthermore, the pixel value written at the time of device launching or the like may be a pixel value that expresses a color other than that of the aforementioned pixel value “00.” Moreover, respective pixels may be written with prescribed pixel values in order to display a prescribed color image. This can be readily achieved by storing respective pixel values composing the aforementioned color image in a not-illustrated non-volatile memory such as an EEPROM or the like, and by transferring the respective pixel values from the non-volatile memory to corresponding addresses in the frame memory 21 at the time of device initialization, for example.

In view of the above explanation, referring to FIG. 6, the pixel value “11” is written in the address range within 640 columns and 480 rows from the starting address (81,61)—i.e., at addresses (p, q) within the range of 81≦p≦720 and 61≦q≦540), and the pixel values “00” are written at the other addresses. Thus, a 640 (wide)×480 (high) VGA screen image is displayed at the central part of the display unit 500 shown in FIG. 1, and the periphery of this screen image becomes black.

The display position of the aforementioned VGA image on the display unit 500 is determined by the value of the starting address SA, and this value is calculated by the starting address calculation unit 25 based on the resolution data RE and the display position selection signal SEL. Specifically, if the display position selection signal SEL provides instructions to display an image at the center of the display unit, the starting address calculation unit 25 calculates the starting address SA (Sx, Sy) based on the following formulae (1).

Sx=(800−Rx)/2+1

Sy=(600−Ry)/2+1 (1)

Here, Rx and Ry are respectively the total number of columns and the total number of rows in the to-be-displayed image. These numbers are included in the resolution data RE,

Based on the starting address SA (Sx, Sy) calculated using the aforementioned formulae (1) and the resolution data RE, the memory control unit 22 sequentially writes the pixel values of a single frame image contained in the display data signal DAT to the address (p, q) within the range Sx≦p≦(Sx+Rx) and Sy≦q≦(Sy+Ry).

The above-described writing operation by the memory control unit 22 in the above manner is completed by a certain point in time. Thereafter, the memory control unit 22 outputs the digital video signal DV that is to be provided to the source driver 300 by sequentially reading out the aforementioned display gradation data stored in the frame memory 21 at addresses (1,1) to (800,600) at a suitable timing that is set in accordance with the control signal CT from the timing generation unit 24 (at a timing for SVGA display). Furthermore, the time of initiation of the aforementioned read-out operation is determined beforehand to be a suitable point in time so that read-out operation is not performed prior to the completion of the write operation of these display gradation data.

This digital video signal DV is supplied to the source driver 300 (as parallel data having a total of 24 bits, 8 bits for each color of RGB). At the source driver 300, this digital video signal DV is converted into analog voltages for respective colors, and the analog voltages are applied to the corresponding video signal wiring lines SL(1) through SL(M) as the drive video signals. The voltages applied as the drive video signals to the video signal wiring lines SL(1) through SL(M) in this manner are applied sequentially to the pixel electrodes Epix of respective pixel formation parts P(n, m) through TFTs 10 that have entered into the conductive state due to sequential application of the active scan signal by the gate driver 400, and the resultant voltages are retained by the pixel capacitances of these pixel formation parts P(n, m). The voltage retained by this pixel capacitance is applied to the liquid crystal and controls the transmittance of light by the display unit 500, and thus an image is displayed. The image is a 640 (wide)×480 (high) VGA image, and as described previously, the surrounding area becomes black.

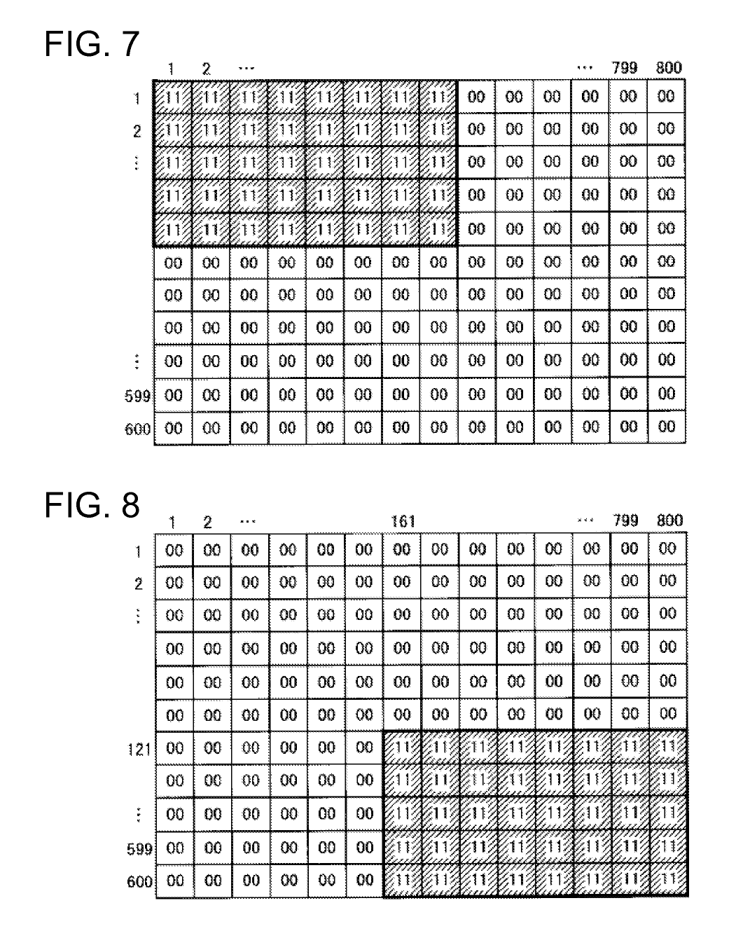

In the aforementioned example, the display position selection signal SEL provides instructions to display the image at the center of the display unit. However, the display position signal SEL may provide instructions to display the image at any position on the display unit, such as at the upper right corner, the upper left corner, the lower right corner, or the lower left corner. Preferably, the display position selection signal SEL is a voltage signal obtained by a CMOS level 3 bit voltage setting, and the image can be displayed at positions corresponding to the setting states of each of the bits. Thus, the display position of the image can be determined by a simple voltage setting. Thus, for example, it is possible to easily determine the display position of the image using three toggle switches, a control signal from the outside, or the like. FIGS. 7 and 8 will be referred to below for a description of cases in which images at the upper left corner and lower right corner of the screen are displayed.

FIG. 7 is a diagram showing the contents of the frame memory to which the pixel values have been written such that an image is to be displayed at the upper left corner of the screen. FIG. 8 is a diagram showing the contents of the frame memory to which the pixel values have been written such that an image is to be displayed at the lower right corner of the screen.

As shown in FIG. 7, when the display position selection signal SEL provides instructions to display the image at the upper left corner of the display unit, the starting address SA (Sx, Sy) is (1,1). Since the contents of the resolution data RE do not change, the starting address calculation unit 25 gives the starting address SA(1,1) to the memory control unit 22. The memory control unit 22 writes sequentially the pixel values of a single frame image included in the display data signal DAT to addresses within the 1≦p≦640 and 1≦q≦480 range of addresses (p, q).

Moreover, as shown in FIG. 8, if the display position selection signal SEL provides instructions to display the image at the lower right corner of the display unit, then the starting address SA(Sx, Sy) is calculated by the following formulae (2).

Sx=800−Rx+1

Sy=600−Ry+1 (2)

Here, since the contents of the resolution data RE do not change, the starting address calculation unit 25 gives the starting address SA (161,121) to the memory control unit 22, and the memory control unit 22 writes sequentially the pixel values for a single frame image included in the display data signal DAT to addresses within the 161≦p≦800 and 121≦q≦600 range of addresses (p, q).

When the aforementioned write operation by the memory control unit 22 is completed, the memory control unit 22 similarly outputs a digital video signal DV to be provided to the source driver 300 by sequentially reading out the aforementioned gradation data from the frame memory 21 at a suitable timing (suitable for a SVGA display). As a result, similarly, the 640 (wide)×480 (tall) VGA image is displayed at the upper left corner or the lower right corner of the display unit 500.

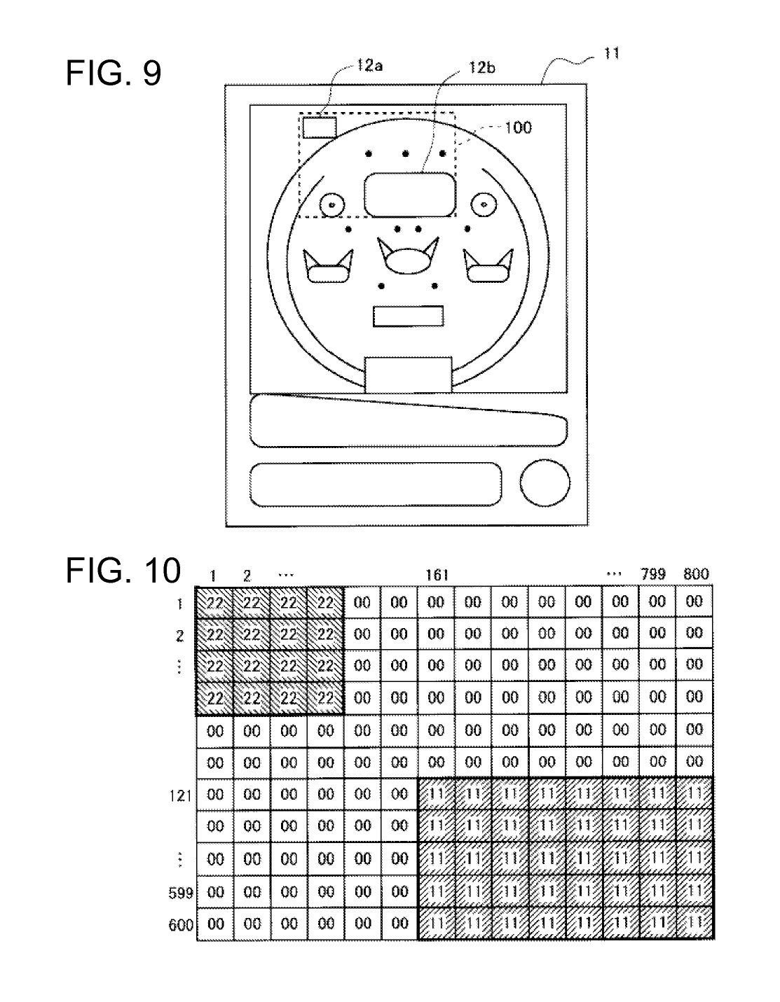

As described above, this liquid crystal display device is capable of displaying an image at the aforementioned position prescribed by the CMOS level 3 bit voltage setting of the display position selection signal SEL. This type of configuration is very advantageous when a liquid crystal display of the present invention is contained in an amusement device, for example. The amusement device containing a liquid crystal display device of the present invention will be described below while referring to FIG. 9.

### 3. STRUCTURE AND OPERATION OF AMUSEMENT DEVICE CONTAINING A LIQUID CRYSTAL DISPLAY DEVICE OF THE PRESENT INVENTION

FIG. 9 is a front external view of an amusement device containing a liquid crystal display device of the present invention. As shown in FIG. 9, this amusement device 11 is a pachinko amusement device and contains the liquid crystal display device 100 of the present embodiment. This liquid crystal display device 100 is fixed at a certain position within the housing of the pachinko amusement device 10 so that the display unit 500 is frontward facing. Although in reality, a frame part (i.e., a non-display unit portion) would be formed at the periphery of the display unit 500, for convenient of the description, the frame part is not illustrated here, and the total surface of the front face of the liquid crystal display device 100 is assumed to have as the size of the display face of the display unit 500.

A front board that is protected by an openable-closable glass plate is placed at the front face of this housing. Multiple impediment nails, prize-winning ports, or the like for pachinko gaming are provided on this front board. Additionally, a first aperture portion 12a and a second aperture portion 12b, which make parts of the aforementioned display unit 500 visible from the front face, are provided on the front board. Here, the display unit 500 displays constant information that does not change (i.e., name, manufacturing company, or the like of the pachinko amusement device 10) through the aforementioned first aperture portion 12a, and displays information that changes (i.e., typical gaming information such as information about prize winning or the like relating to pachinko gaming) through the aforementioned second aperture portion 12b in the form of animation, for example.

In order to realize a display state such as that described above, at the time of device activation, the liquid crystal display device 100 transfers the pixel values representing the aforementioned constant information from a non-illustrated EEPROM, for example, and writes it onto the frame memory 21. Also, the contents of the display position selection signal SEL are set, for example, by 3 non-illustrated dip switches or the like to cause display of an image at the lower right corner of the screen, and the aforementioned variable information is written frame by frame to a certain position of the frame memory 21.

FIG. 10 is a diagram showing the contents of the frame memory to which respective pixel values have been written such that the aforementioned images are to be displayed respectively at the upper left corner and lower right corner of the screen. In order to write the pixel values as shown in this FIG. 10, pixel values indicating the aforementioned constant information (as a matter of convenience, all values set here to “22”) are written at the time of device activation from the non-illustrated EEPROM to the memory control unit 22 in the aforementioned manner at addresses within the range for display at the first aperture portion 12a. Moreover, based on the display position selection signal SEL, the starting address calculation unit 25 provides the starting address SA (161,121) to the memory control unit 22. Then, the memory control unit 22 sequentially writes pixel values of a single frame image (here, all indicated as “11” for convenience) included in the display data signal DAT, which is at VGA resolution, onto addresses within the 161≦p≦800 and 121≦q≦600 range of addresses (p, q).

Thereafter, the memory control unit 22, at a suitable timing (suitable for a SVGA display), reads out sequentially the aforementioned gradation data from the frame memory 21 so that respective VGA images are displayed at the upper left corner of the display unit 500 (visible through the first aperture portion 12a) and at the lower right corner of the display unit 500 (visible through the second aperture portion 12b).

The pachinko amusement devices 11 shown in FIG. 9 having display units showing animated information that changes (e.g., information on prize winning or the like) in this manner often have such display units arranged above the prize-winning ports entered by pachinko balls, and such display units often have a large extra space above the prize-winning ports. Thus many pachinko amusement devices 11 are capable of containing even a relatively large display device. Moreover, the images displayed by the pachinko amusement device 11 are often produced as relatively low resolution images, such as VGA images or the like. Thus, a relatively large SVGA resolution liquid crystal display device 100 is preferably disposed above the prize-winning ports, and the display of the VGA image is preferably at the downward portion (lower right corner portion of the display unit 500) of the liquid crystal display device 100.

Moreover, if the aforementioned constant information is displayed at the first aperture portion 12a, for example, in comparison to the affixing of a seal indicating a company name at this location, it is possible to perform a more impressive display for the user, and it is also possible to suppress the manufacturing cost because there is no need to add a liquid crystal display device for displaying the company name. Furthermore, the first aperture portion 12a and the second aperture portion 12b are preferably arranged with a certain distance between these aperture portions. Thus, the liquid crystal display device 100 is preferably relatively large, and the aforementioned VGA image to be displayed at the second aperture portion 12b preferably is displayed in the vicinity of the edge part of the liquid crystal display device 100 (e.g., the lower right corner portion).

### 4. EFFECTS

For the aforementioned type of display control circuit of the present embodiment and an active matrix type display device equipped with such a display control circuit, when image data are received at a resolution (VGA in this case) lower than the resolution capable of being displayed on the entire display screen (SVGA in this case), the starting address calculation unit calculates the starting address corresponding to the position that becomes the origin point on the screen set by the display position selection signal SEL received from the exterior of the device, and the image data of a single frame image included in the display data signal DAT are written sequentially in a prescribed region. As a result, this image is displayed within a certain region from the aforementioned origin point position, instead of being displayed on the entire display screen. It is thus possible to perform display suitable for display devices having specific usage, e.g., devices for amusement or the like.

### 5. MODIFIED EXAMPLES

In the aforementioned embodiment, resolution data RE that were determined automatically by the resolution determination unit 23 were used. Alternatively, resolution data RE may be set by a user and my be received from the outside, and the resolution determination unit 23 may be omitted. For example, the starting address calculation unit 25 may calculate the starting address SA based on a display position selection signal SEL that includes resolution data RE provided from outside of the device. Moreover, if the display resolution of the image displayed based on the display data signal DAT provided from the outside is fixed to one value, the resolution data RE may be omitted. Also, when the display position of this image on the display unit 500 is fixed at one position, the display position selection signal SEL may be omitted.

In the aforementioned embodiment, the memory control unit 22 was configured so as to write the image data of a single frame image within a certain address range using as the origin point the starting address SA calculated by the starting address calculation unit 25. Alternatively, the memory control unit 22 may calculate the starting address, or the starting address calculation unit 25 may calculate all corresponding addresses including the starting address, and the memory control units 22 may write the image data in accordance with such calculated addresses.

According to the described examples of the aforementioned embodiments, the display resolution of the input image indicated by the display data signal DAT and received from the outside was VGA, and the image display resolution of the display unit 500 was SVGA. However, the present invention is also applicable other cases as long as the display resolution of the input image is lower than the display resolution of the display image, such as where the display resolution of the input image is SVGA and the display resolution of the display image is XGA.

Furthermore, an active matrix type liquid crystal display device has been explained as an example. However, the present invention is applicable to other devices, as long as the device is an active matrix type display device and is capable of storing pixel values in a frame memory.

### INDUSTRIAL APPLICABILITY

The present invention is suitable for use in an active matrix type display device and in a display control circuit for such an active matrix display device, such as a liquid crystal display device or the like using switching elements such as thin film transistors or the like. This present invention is suitable for a display device for specialty applications and a display control circuit, for specialty applications, such as amusement device or the likes.

### DESCRIPTION OF REFERENCE CHARACTERS

10 TFT (switching element)
11 pachinko amusement device
12a, 12b first and second aperture parts
21 frame memory
22 memory control unit
23 resolution determination unit
24 timing generation unit
25 starting address calculation unit
26 output data memory unit
100 liquid crystal display device
200 display control circuit
300 source driver
400 gate driver
500 display unit
DAT display data signal
DV digital video signal
TS timing control signal
SEL display position selection signal
Clc liquid crystal capacitance
Cs parasitic capacitance
Ecom common electrode
Epix pixel electrode
GL(n) scan signal wiring line (n=1−N)
SL(m) data signal wiring line (m=1−M)
P(n, m) pixel formation part (n=1−N, m=1−M)

1. A display control circuit for receiving from an outside an input signal including a plurality of display data for displaying a plurality of pixels constituting an input image and for outputting an image signal for displaying a display image that includes said input image, the display control circuit comprising:
a frame memory that stores respective display data to be included in said image signal by address;
an address calculation unit that, in accordance with a display resolution of said input image, calculates addresses at which said plurality of display data for said plurality of pixels constituting said input image are stored, the display resolution of said input image being lower than a display resolution of said display image; and
a memory control unit that writes said plurality of display data included in said input signal into said frame memory at the corresponding addresses that have been calculated by said address calculation unit, the memory control unit outputting said image signal by sequentially reading out said stored plurality of display data.

2. The display control circuit according to claim 1, wherein said address calculation unit receives instructions specifying a range of addresses corresponding to a position of said plurality of display data for said plurality of pixels, the position of said plurality of display data being corresponding to a position of said input image within said display image, and said address calculation unit calculates said corresponding addresses in accordance with the instructions.

3. The display control circuit according to claim 2, wherein said address calculation unit receives instructions specifying the range of addresses such that said input image is displayed within said display image at a position that contacts an edge of said display image.

4. The display control circuit according to claim 3, wherein said address calculation unit stores beforehand a plurality of ranges of addresses that include said range of addresses, and receives instructions to select one range among said plurality of ranges of addresses.

5. The display control circuit according to claim 1, wherein said memory control circuit controls said frame memory such that at a time of activation or when the display resolution of said input image is changed, a plurality of prescribed display data are written onto a prescribed range of addresses that are different from the addresses for said plurality of display data included in said input signal.

6. The display control circuit according to claim 5, wherein said memory control unit controls said frame memory such that a plurality of display data for displaying a still image that does not change since said time of activation or change in the display resolution of said input image are written onto said prescribed range of addresses.

7. The display control circuit according to claim 1,
wherein the display control circuit further comprises a resolution determination unit that determines the display resolution of said input image based on a synchronization signal included in said input signal, and
wherein said address calculation unit calculates said addresses in accordance with the display resolution of said input image received from said resolution determination unit.

8. An active matrix type display device comprising:
a display control circuit as set forth in claim 1;
a plurality of video signal wiring lines;
a plurality of scan signal wiring lines intersecting said plurality of video signal wiring lines;
a plurality of pixel formation parts disposed in a matrix corresponding to respective intersections between said plurality of video signal wiring lines and said plurality of scan signal wiring lines, each of the plurality of pixel formation parts including a switching element that becomes conductive or non-conductive in response to a prescribed scan signal applied to a scan signal wiring line passing the corresponding intersection point; and
a drive control circuit for applying to said plurality of video signal wiring lines a plurality of video signals corresponding to said image signal output from said display control circuit, and for applying said scan signal to said plurality of scan signal wiring lines.

9. A display control method for receiving from an outside an input signal including a plurality of display data for displaying a plurality of pixels constituting an input image, and for outputting an image signal for displaying a display image including said input image, the method comprising:
an address calculation step of calculating addresses at which a plurality of data for a plurality of pixels constituting said input image are written in a frame memory in accordance with a display resolution of said input image, the display resolution of said input image being lower than a display resolution of said display image, said frame memory being for storing respective display data to be included in said image signal by address; and
a memory control step of outputting said image signal, the memory control step including writing said plurality of display data included in said input signal into said frame memory at the corresponding addresses calculated in said address calculation step, and sequential reading out said stored plurality of display data.
